(19) United States
(12) Patent Application Publication
(10) Pub. No.: US 2007/0278321 A1
(43) Pub. Date: Dec. 6, 2007

(54) Air exhaust system for a fluid circulation system

(76) Inventor: Feng Liu, Shanghai (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/809,520

(22) Filed: Jun. 1, 2007

(30) Foreign Application Priority Data
Jun. 2, 2006 (CN) 200620042364.7

(51) Int. Cl. G05D 15/00; F23N 1/08

(52) U.S. Cl. 236/20 R; 126/FOR. 129

(57) ABSTRACT

An exhaust system includes a pump, a cylinder installed on the pump, an exhaust pipe, a flow restrictor, an output pipe. The flow restrictor includes an inlet fluidly connected with an outlet of the pump, and an outlet fluidly connected with an inlet of the output pipe. The exhaust pipe includes an inlet fluidly connected to the flow restrictor and an outlet in fluid communication with an inner chamber at the top of the cylinder.

### DESCRIPTION OF THE INVENTION

1. Field of the Invention

This present invention relates to an air exhaust system for a fluid circulation system, more particularly, relates to a pressure-type air exhaust system.

2. Background of the Invention

In a water circulation system, air dissolved in the water may be released and rise from the water, and moreover, if the water in the circulation system is heated, water may vapor. Such released air and/or water vapor, when accumulated, may not only block the water circulation, but also make the circulation system unbalanced. In a heat dissipation system, certain parts of a radiator in the system may trap air and be insulated, and thus the heat transferring efficiency is reduced. In a pressure water circulation system, during operation of a water pump, due to the fact that massive air may be dissolved in the water, air may be easily released from the water and trapped in a hermetic cylinder of the water pump or other chamber in the circulation system. The trapped air may cause the pressure of the water in the circulation system to drop and may also affect the life-span of the water pump. Furthermore, during the operation of the circulation system, if the trapped air moves with the water flow, it may cause elements of the circulation system, such as the water pump, to operate with unbalanced load in a certain time frame, and that may also reduce the life-span of the water pump. It may also create noise when the trapped air moves with the water flow in the circulation system. In order to prevent the air from being trapped in the circulation system, an automatic exhaust valve has been adopted. The structure of the traditional automatic exhaust valve is similar to a float structure, which mainly depends upon the relationship between the float and the water level. Its principle is similar to that of a float ball valve often used in flush toilets. The congeries of air bubbles in the system may make the float ball to drop along with the water level to turn on the exhaust valve. The traditional exhaust valve has a large size and is expensive, the structure of which is also complicated, and not reliable.

The disclosed system is directed to overcoming one or more of the problems set forth above.

### SUMMARY OF THE INVENTION

In one aspect, the present disclosure is directed to a pressure-type air exhaust system including a pump, a cylinder installed on the pump, an exhaust pipe, a flow restrictor, an output pipe. The flow restrictor includes an inlet fluidly connected with an outlet of the pump, and an outlet fluidly connected with an inlet of the output pipe. The exhaust pipe includes an inlet fluidly connected to the flow restrictor and an outlet in fluid communication with an inner chamber at the top of the cylinder.

According to another aspect, the flow restrictor includes a first section and a second section, each section having a substantially trumpet shape. The first section and the second section are connected at their narrow ends forming a relatively narrow section. The inlet of the exhaust pipe is fluidly connected to the relatively narrow section.

### BRIEF DESCRIPTION OF THE DRAWINGS

FIG. 1 shows a perspective view of a pump system with an air exhaust system according to one embodiment of the present invention;

FIG. 2 is a schematic and cross-sectional view of the pump system with the air exhaust system of FIG. 1;

FIG. 3 shows a perspective view of a flow restrictor used in the air exhaust system; and

FIG. 4 is a schematic and cross-sectional view of the flow restrictor of FIG. 3.

Reference number glossary: 1 pump, 2 cylinder, 3 input pipe, 4 exhaust pipe, 5 flow restrictor, 6 output pipe, 7 output connecting pipe, 8 inlet of the exhaust pipe, 9 inlet section of the flow restrictor, 10 outlet section of the flow restrictor.

### DESCRIPTION OF THE EMBODIMENTS

With an application of the principle of a Venturi tube, the present invention utilizes a flow restrictor at an inlet end of an output pipe, the flow restrictor having an inner diameter that decreases along a longitudinal axis of the flow restrictor to a relatively narrow point or section, and then increases along the longitudinal axis. In operation, the narrow point or section has the lowest fluid pressure. The arrangement in diameter of the flow restrictor creates a pressure differential between the incoming flow at the section with a larger diameter and the flow at the narrow point or section. Through an exhaust pipe fluidly connected between the narrow section and a chamber where air is trapped, the trapped air can be sucked into the narrow section and thus into the water flow. A mixture of fluid and air is then output through the water output pipe.

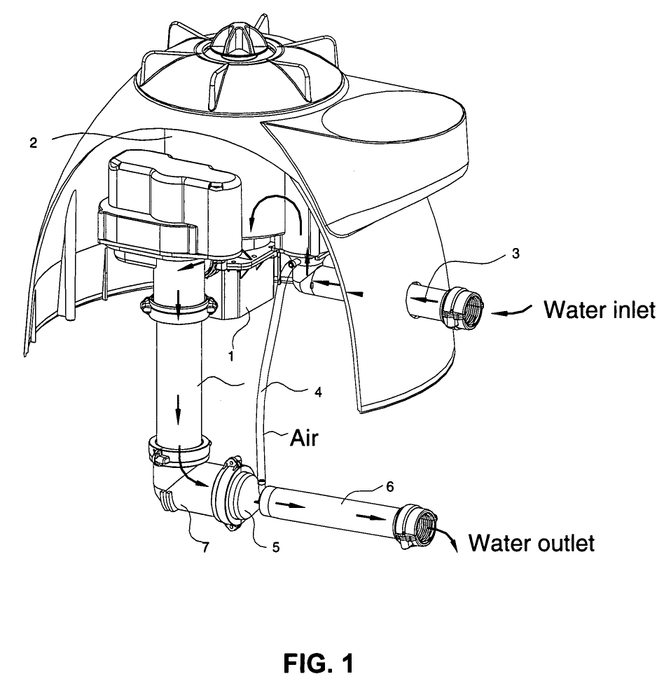

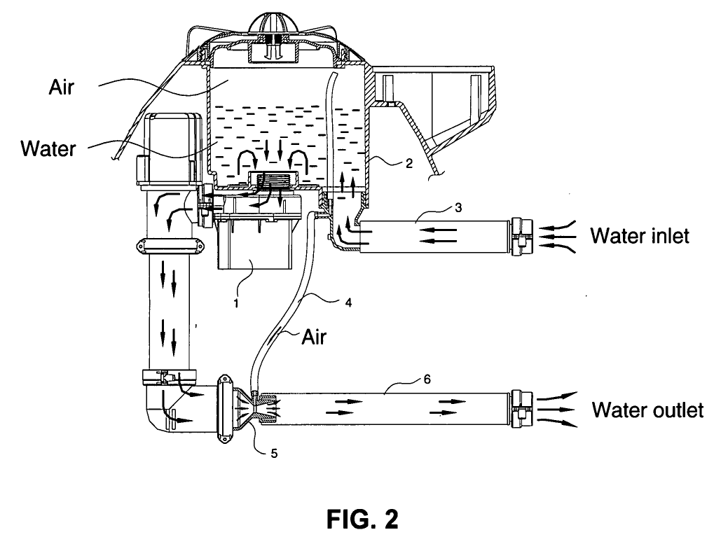

As shown in FIGS. 1 and 2, a fluid circulation system may include a pump 1 and a cylinder 2 installed on the pump 1. The cylinder 2 may include an inlet, which is connected to an outlet of an input pipe 3, at the bottom the cylinder 2. The pump 1 has an inlet, which is connected to an opening in a central bottom area of the cylinder 2. An output pipe 6 is fluidly connected to an outlet of the pump 1. A flow restrictor 5 is connected between the outlet of the pump 1 and the output pipe 6.

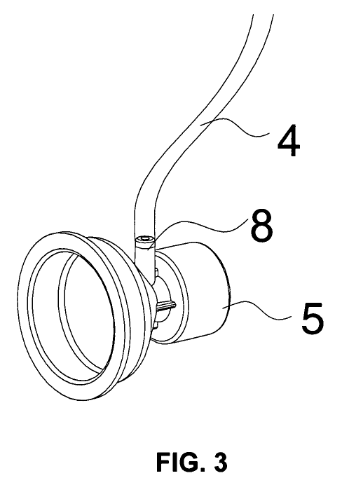

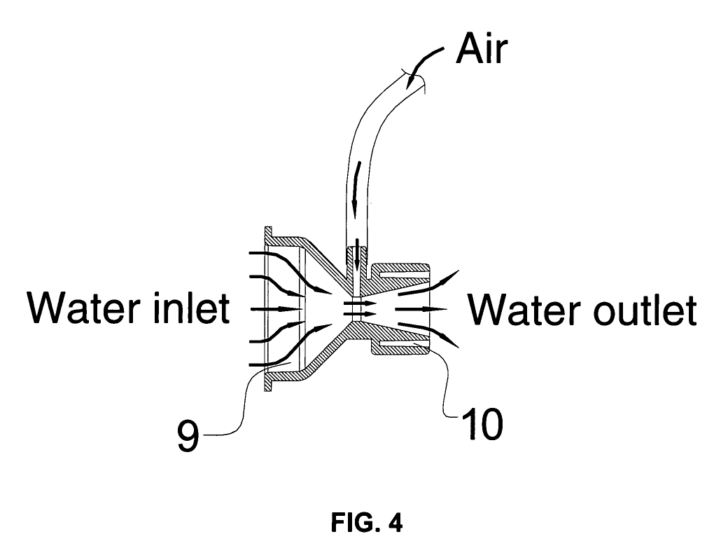

As shown in FIGS. 3 and 4, the flow restrictor 5 may extend along a longitudinal axis and include two sections, an inlet section (a first section) 9 and an outlet section (a second section) 10, each section employing a substantially trumpet shape. The inlet section 9 and the outlet section 10 are connected at their narrow ends, forming a relatively narrow point or section in the middle. In one embodiment, as shown in FIG. 4, the average or the largest diameter of the inlet section 9 is bigger than the average or largest diameter of the outlet section 10. One end (an outlet) 8 of an exhaust pipe 4 is fluidly connected to the narrow section, where the two sections 9 and 10 are connected. The other end (an inlet) of the exhaust pipe 4 is in fluid communication with an inner chamber at the top of the cylinder 2, which often contains air released or vaporized from the fluid. The inlet section 9 of the flow restrictor 5 is connected with an outlet of an output connecting pipe 7, whose inlet is connected to the pump 1.

It will be apparent to those skilled in the art that various modifications and variations can be made to the air exhaust system. Other embodiments will be apparent to those skilled in the art from consideration of the specification and practice of the disclosed air exhaust system. It is intended that the specification and examples be considered as exemplary only, with a true scope being indicated by the following claims and their equivalents.

What is claimed is:

1. An air exhaust system comprising a pump, a cylinder installed on the pump, an exhaust pipe, a flow restrictor, an output pipe, wherein the flow restrictor includes an inlet fluidly connected with an outlet of the pump, and an outlet fluidly connected with an inlet of the output pipe, and wherein the exhaust pipe includes an inlet fluidly connected to the flow restrictor and an outlet in fluid communication with an inner chamber at the top of the cylinder.

2. The air exhaust system of claim 1, wherein the flow restrictor includes a first section and a second section, wherein each section has a substantially trumpet shape, the first section and the second section being connected at their narrow ends forming a relatively narrow section, and wherein the inlet of the exhaust pipe is fluidly connected to the relatively narrow section.
